(19) United States
(12) Patent Application Publication
(10) Pub. No.: US 2026/0356243 A1
(43) Pub. Date: Nov. 12, 2026

(54) EXCESSIVE ENERGY PREDICTION IN ELECTRIFIED POWERTRAIN SYSTEMS

(71) Applicant: FCA US LLC, Auburn Hills, MI (US)

(72) Inventors: Kamal Bouyoucef, Auburn Hills, MI (US); Hanane Hemi, Fes (MA); Feisel Weslati, Auburn Hills, MI (US); Sina Shojael, Auburn Hills, MI (US)

(21) Appl. No.: 19/199,713

(22) Filed: May 6, 2025

(51) Int. Cl. B60L 58/15

(52) U.S. Cl. CPC B60L 58/15; B60L 2240/26; B60L 2240/54; B60L 2240/622; B60L 2240/68; B60L 2250/18; B60L 2260/54

(57) ABSTRACT

An excessive power/energy prediction system for an electrified vehicle (EV) includes a controller configured to determine a sum of power/energy generated by the EV for a predetermined time period, determine a sum of power/energy to be utilized by the EV for the predetermined time period, determine an available positive power/energy of the EV based on a difference between the determined sum of power/energy generated by the EV and the determined sum of power/energy to be utilized by the EV, determine an amount of power/energy of a high voltage (HV) battery system for the predetermined time period, determine a maximum amount of power/energy the HV battery system can store for the predetermined time period, and determine when an excess generated power/energy will occur during the predetermined time period based on a difference between the determined available positive power/energy and the determined maximum amount of power/energy the HV battery system can store.

### FIELD

The present application generally relates to electrified vehicles and, more particularly, to systems for predicting excessive energy in electrified vehicles.

### BACKGROUND

Electrified vehicles (EVs) typically include at least one electric traction motor powered by a high voltage battery system, which is capable of storing a finite amount of energy. In some situations, EVs may have an excess of power/energy due to, for example, excessive engine generated power, regenerative braking energy, fuel-cell system generated power, and/or an overcharged high voltage battery. This excess power/energy must be quickly dissipated to enable the EV to operate normally and/or prevent harmful events. One common solution to dissipate excessive energy is to run any available components (e.g., heaters, fans, etc.). However, such a solution results in vehicle energy loss that reduces vehicle range. Accordingly, while these conventional systems work well for their intended purpose, there exists an opportunity for improvement in the relevant art.

### SUMMARY

According to one example aspect of the invention, an excessive power/energy prediction system for an electrified vehicle (EV) having an electrified powertrain including an electric traction motor powered by a high voltage (HV) battery system is provided. In one exemplary implementation, the excessive power/energy detection system includes a controller having one or more processors and a non-transitory computer-readable storage medium having a plurality of instructions stored thereon, which, when executed by the one or more processors, cause the one or more processors to perform operations including determine a sum of power/energy generated by the EV for a predetermined time period; determine a sum of power/energy to be utilized by the EV for the predetermined time period; determine an available positive power/energy of the EV based on a difference between the determined sum of power/energy generated by the EV and the determined sum of power/energy to be utilized by the EV; determine a current amount of power/energy of the HV battery system for the predetermined time period; determine a maximum amount of power/energy the HV battery system can store for the predetermined time period; and determine when an excess generated power/energy will occur during the predetermined time period based on a difference between the determined available positive power/energy of the EV and the determined maximum amount of power/energy the HV battery system can store.

In addition to the foregoing, the described excessive power/energy detection system may include one or more of the following features: wherein the controller is further configured to determine a current state of charge (SOC) of the HV battery system, and determine a maximum SOC of the HV battery system; wherein the controller is further configured to determine if the current SOC is greater than or equal to the maximum SOC; wherein the controller is further configured to determine the excess generated power/energy is equal to the determined available positive power/energy, if the current SOC is greater than or equal to the maximum SOC; wherein the predetermined time period is a current drive cycle; and wherein the predetermined time period is a navigational route.

In addition to the foregoing, the described excessive power/energy detection system may include one or more of the following features: wherein the navigational route is based on a destination entered into a navigation system associated with the EV; wherein the navigational route is based on historical driving data; and wherein the determined sum of power/energy to be utilized by the EV for the predetermined time period is based on: (i) an electric traction motor power consumption input, (ii) a thermal management system thermal state input and thermal power consumption input, (iii) an HVAC system power consumption input, and (iv) a vehicle accessory power consumption input.

In addition to the foregoing, the described excessive power/energy detection system may include one or more of the following features: wherein the determined sum of power/energy to be utilized by the EV for the predetermined time period is further based on: (a) a vehicle load/cargo weight estimation, (b) a vehicle occupancy status, (c) a tire pressure, (d) a distance to a destination of travel, (e) a time to the destination of travel, (f) speed limits along the navigational route, (g) traffic information along the navigational route, (h) a selected vehicle drive mode, (i) a selected regenerative braking mode, (j) a vehicle speed, (k) a vehicle historic energy usage from memory, and (l) an individual driver habits profile.

In accordance with another example aspect of the invention, an excessive power/energy prediction method for an electrified vehicle (EV) having an electrified powertrain including an electric traction motor powered by a high voltage (HV) battery system is provided. In one example implementation, the method includes determining, by a controller having one or more processors, a sum of power/energy generated by the EV for a predetermined time period; determining, by the controller, a sum of power/energy to be utilized by the EV for the predetermined time period; determining, by the controller, an available positive power/energy of the EV based on a difference between the determined sum of power/energy generated by the EV and the determined sum of power/energy to be utilized by the EV; determining, by the controller, a current amount of power/energy of the HV battery system for the predetermined time period; determining, by the controller, a maximum amount of power/energy the HV battery system can store for the predetermined time period; and determining, by the controller, when an excess generated power/energy will occur during the predetermined time period based on a difference between the determined available positive power/energy of the EV and the determined maximum amount of power/energy the HV battery system can store.

In addition to the foregoing, the described method may include one or more of the following features: determining, by the controller, a current state of charge (SOC) of the HV battery system, and determining, by the controller, a maximum SOC of the HV battery system; determining, by the controller, if the current SOC is greater than or equal to the maximum SOC; determining, by the controller, the excess generated power/energy is equal to the determined available positive power/energy, if the current SOC is greater than or equal to the maximum SOC; wherein the predetermined time period is a current drive cycle; wherein the predetermined time period is a navigational route; and wherein the navigational route is based on a destination entered into a navigation system associated with the EV.

In addition to the foregoing, the described method may include one or more of the following features: wherein the navigational route is based on historical driving data; and wherein the determined sum of power/energy to be utilized by the EV for the predetermined time period is based on: (i) an electric traction motor power consumption input, (ii) a thermal management system thermal state input and thermal power consumption input, (iii) an HVAC system power consumption input, and (iv) a vehicle accessory power consumption input.

In addition to the foregoing, the described method may include one or more of the following features: wherein the determined sum of power/energy to be utilized by the EV for the predetermined time period is further based on: (a) a vehicle load/cargo weight estimation, (b) a vehicle occupancy status, (c) a tire pressure, (d) a distance to a destination of travel, (e) a time to the destination of travel, (f) speed limits along the navigational route, (g) traffic information along the navigational route, (h) a selected vehicle drive mode, (i) a selected regenerative braking mode, (j) a vehicle speed, (k) a vehicle historic energy usage from memory, and (l) an individual driver habits profile.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an example electrified vehicle having an excessive power/energy prediction system according to the principles of the present application;

FIG. 2 is a graph illustrating example vehicle conditions during example excessive power/energy scenarios, according to the principles of the present application; and

FIG. 3 is a flow diagram of an example excessive power/energy prediction method for an electrified vehicle, according to the principles of the present application.

### DESCRIPTION

As previously discussed, electrified vehicles (EVs) may experience events where the vehicle generates excessive power/energy, which may affect vehicle operation and reduce vehicle range. Accordingly, described herein are systems and methods configured to predict/identify excessive power/energy generation scenarios such that counteractive measures can be quickly administered.

With current energy management platforms, excessive generated power/energy cannot be used by the vehicle for its operation, it cannot be stored in the high voltage (HV) battery system if it is fully charged and/or under restrictive conditions, and it can result in an inoperative or hazardous vehicle situation. Conventional solutions simply dissipate the excessive power/energy generation by running any available electric components/actuators such as heaters, compressors, fans, and pumps. This conventional solution is suboptimal as it operates in a brute force manner, reduces hardware life, and may exacerbate vehicle range issues.

Accordingly, the system described herein advantageously includes an innovative strategy that proactively predicts/detects EV operation events in which the vehicle generates excessive power and/or energy. In one example, rather than operating reactively like conventional solutions, the system predicts, before and/or during a trip, excessive power/energy events to enable optimal and robust control solutions. As such, the vehicles may be maintained hazard-free and range deterioration-free while allowing optimal operation.

In one example, the excessive power/energy can be defined as an excess of power/energy

$$( {Δ}_{E}^{x} ( t ) )$$

that can neither be utilized for vehicle operation nor be stored in the HV battery system. The excessive power/energy detection is achieved by identifying the instances where

$${Δ}_{E}^{x} ( t )$$

is positive. In some cases, a certain number of the vehicle energy trajectories needed to determine

$${Δ}_{E}^{x} ( t )$$

can be predicted based upon the trip and vehicle conditions. They can be generated before the departure and updated during the trip.

As previously noted, an EV may generate excessive power/energy during certain scenarios. This excessive power/energy may be problematic if, for example, the vehicle cannot utilize the power/energy for operation (e.g., propulsion), the HV battery system is fully charged, and/or the HV battery system is under restrictive conditions. Such scenarios may occur, for example, due to (i) excessive engine generated power, (ii) excessive regenerative braking, (iii) excessive fuel cell system generated power, or (iv) an overcharged HV battery.

Conventional solutions to excessive power/energy generation include dissipation of that power/energy by running any available vehicle electrical components that consumer power (e.g., heaters, compressors, fans, pumps, etc.). However, this dissipation strategy may result in energy loss that reduces vehicle range, reduced durability of the electrical components, damage to the electrical components when forcing non-optimal operation, and reduced recovery time.

Accordingly, the systems and methods described herein provide an energy strategy configured to predict excessive power/energy events before or during a trip. During vehicle operation, an HV battery can store positive power/energy

$${Δ}_{E}^{A} ( t )$$

available on the HV bus that corresponds to the difference between the power/energy generated by the vehicle

$$( {E}_{V}^{G} ( t ) )$$

and the power/energy used by the vehicle

$$( {E}_{V}^{U} ( t ) )$$

for its operation. Thus,

$${Δ}_{E}^{A} ( t ) = {E}_{V}^{G} ( t ) - {E}_{V}^{U} ( t ) .$$

Accordingly, the HV battery power/energy E_{B} (t), at any time t, can be determined as:

$${E}_{B} ( t ) = {E}_{B} ( t - 1 ) + {Δ}_{E}^{A} ( t ) .$$

In the event of the battery is fully charged (i.e., maximum power/energy

$${E}_{B}^{max} ) ,$$

the excess of power/energy

$${Δ}_{E}^{x} ( t )$$

becomes:

$${Δ}_{E}^{x} ( t ) = {Δ}_{E}^{A} ( t ) - {Δ}_{E B}^{max} ( t ) ,$$

where

$${Δ}_{E B}^{max} ( t ) = {E}_{B}^{max} - {E}_{B} ( t - 1 ) ,$$

as the maximum power/energy the HV battery can store during that iteration.

In the event the HV battery is unable to store any power/energy, the excess power/energy

$${Δ}_{E}^{x} ( t )$$

is:

$${Δ}_{E}^{x} ( t ) = {Δ}_{E}^{A} ( t ) .$$

The excessive power/energy detection is ultimately achieved by determining the instances where

$${Δ}_{E}^{x} ( t )$$

is positive.

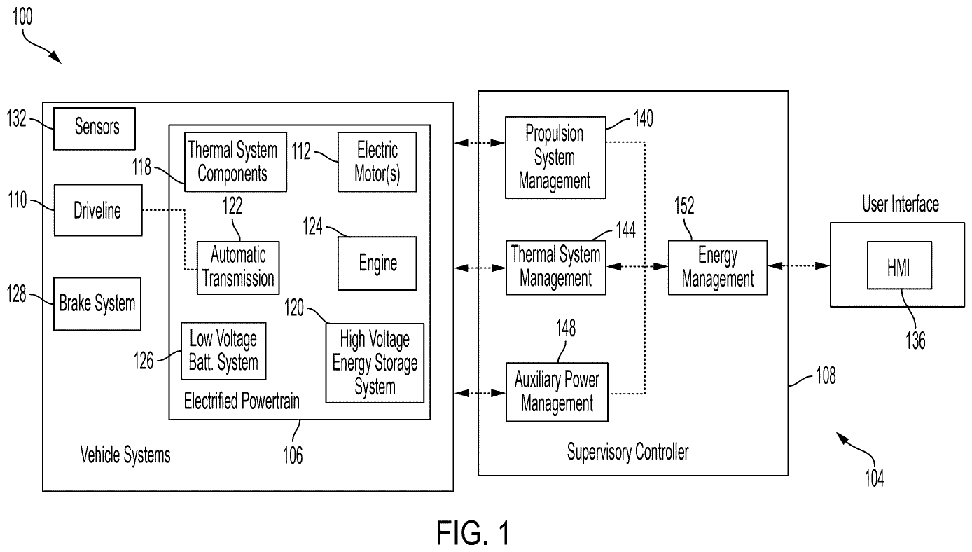

Referring now to FIG. 1, a functional block diagram of an example electrified vehicle 100 having an excessive power/energy prediction/detection system 104 according to the principles of the present application is presented. The electrified vehicle 100 could be any suitable type of electrified vehicle, including, but not limited to, battery electric vehicle (BEV), a hybrid electric vehicle (HEV), or a fuel cell electric vehicle (FCEV). The vehicle 100 generally includes an electrified powertrain 106 and a supervisory controller 108. The electrified powertrain 106 is configured to generate and transfer drive torque to a driveline 110 for vehicle propulsion. The electrified powertrain 106 includes one or more electric traction motors 112 each configured to generate mechanical drive torque using energy (e.g., electrical current) supplied by a high voltage (HV) battery or energy storage system 120. For example, an inverter (not shown) could be used to convert the direct current (DC) from the HV battery system 120 to three-phase alternating current (AC) to power the electric traction motor(s) 112. A transmission 122 (e.g., an automatic transmission) is configured to transfer the drive torque from the electrified powertrain 106 to the driveline 110.

In some configurations, the electrified powertrain 106 may also include an internal combustion engine 124 configured to combust a mixture of air and fuel (gasoline, diesel, etc.) to generate mechanical torque for vehicle propulsion and/or conversion to electrical energy, such as for recharging battery system 120. It will be appreciated that the electrified powertrain 106 could alternatively include another energy generator, such as a hydrogen or other suitable fuel cell system (e.g., FCEV). A low voltage battery system 126 (e.g., a 12-volt (V) battery) is configured to power low voltage components and accessory loads of the electrified vehicle 100. A brake system 128 is configured to selectively brake the vehicle 100 and includes a regenerative braking capability configured to recharge the HV battery system 120. Additionally, thermal system components 118 may include various actuators (e.g., pumps, valves, fans, heaters, compressors, etc.) utilized to thermally manage various electrified powertrain systems (e.g., 112, 120, 122, 124). In some examples, these actuators may also be utilized to dissipate excess power/energy when conventional dissipation solutions are implemented.

The supervisory controller 108 is a control system configured to control the electrified powertrain 106 to generate an amount of drive torque to satisfy a torque request provided by a driver/operator via a driver/user interface 130 (e.g., an accelerator pedal). In one example, the excessive power/energy prediction/detection system 104 is implemented into the supervisory controller 108. A sensor system 132 is configured to measure operating parameters of the electrified vehicle 100, such as, but not limited to, speeds/accelerations, pressures, temperatures, and electrical parameters (voltage, current, state of charge, etc.). The sensors 132 may also interact with other vehicle systems, such as the thermal system components 118 and user interface 130. a GPS navigation/maps system 134. The supervisory controller 108 is also in signal communication with a human machine interface (HMI) 136 such as, for example, an instrument panel cluster or other display, configured to display information to the driver and/or receive input therefrom. The HMI 136 may also include an in-vehicle infotainment/GPS/navigation system.

The vehicle 100 further includes one or more thermal systems (not specifically shown) and one or more auxiliary systems (not specifically shown). The thermal systems include, for example, systems configured to thermally manage or condition specific environments of the vehicle 100, such as a cabin of the vehicle 100, the HV battery system 120, the automatic transmission 122, other power electronics, and the like. The auxiliary systems include, for example, a plurality of auxiliary loads (e.g., low voltage auxiliary loads, such as 12 Volt (V) auxiliary loads including valves, pumps, fans, lamps, and the like). The supervisory controller 108 is also configured to perform at least a portion of the excessive energy generation detection techniques of the present disclosure via a propulsion systems management controller 140, a thermal systems management controller 144, an auxiliary systems management controller 148, and an energy management controller 152. This includes receiving various system/data inputs, including data from sensors 132 and user (e.g., driver) interaction with the user interface 130 (e.g., HMI/Nav 136). In one example, the thermal systems management controller 144 is configured to receive input regarding a thermal state and a thermal consumption of the electrified vehicle 100.

In some examples, the supervisory controller 108 is in signal communication with and configured to receive input from various vehicle components such as, for example, an electric drive module (EDM), an accessory power module (APM), on-board charging module (OBCM), a battery management system (BMS), an HVAC module, a brake system module (BSM), a body control module (BCM), an occupant restraint controller (ORC), and an advanced driver assistance system (ADAS), which may be part of the sensor system 132.

For example only, the EDM may be configured to operate in either a propulsion mode to convert electrical energy from the HV battery system 120 into the mechanical energy required for vehicle movement, or a regenerative mode to convert vehicle kinetic energy back into the HV battery system 120 (e.g., via regenerative brake system 128). The EDM may be configured to provide input signals indicating a power consumption of the electric motor. The APM may be configured to convert HV battery power into low voltage power (e.g., 12V) for on-board computers and other accessory body components. The APM may be configured to provide input signals indicating a power consumption of the vehicle accessories. The OBCM may be a HV charging module configured to communicate with vehicle charging equipment, the supervisory controller 108, and an external charging station to provide AC charging power into the HV battery system 120. The OBCM may be configured to provide input signals indicating an available charge power.

The BMS may be configured to manage physical and electrical components of the HV battery system 120. The BMS may be configured to provide input signals indicating state of charge (SOC), power consumption/limits, and temperatures of the HV battery system 120. The HVAC module may be an interface for cabin climate setting selection and climate temperature targets. The HVAC module may be configured to provide input signals indicating HVAC power consumption and HVAC system state (e.g., heating, cooling, etc.). The BSM (e.g., 128) may interface with the brake pedal, braking components, and wheel speeds (not shown) to determine vehicle speed and control regenerative and friction braking. The BSM may be configured to receive input signals indicating vehicle speed, brake pedal actuation, and tire pressure.

The HVAC module may control cabin comfort according to user settings/targets entered into the user interface 130. The HVAC module is configured to operate/actuate various HVAC systems/devices (e.g., blower, doors, AC compressor, heater, valves, etc.) to ensure thermal functionality (e.g., heating, cooling, air circulation). The HVAC module

The BCM may interface with vehicle body modules/components such as, for example, supervisory controller 108, brake system 128, user interface 130, the ORC, an engine control module (ECM), and the steering wheel/column control module. The BCM may be configured to receive input signals indicating ignition switch state, trailer sensing, windows state, and HMI requests/states (e.g., HVAC, radio, etc.). The ORC may interface with vehicle seatbelts, airbags, and seat weight sensors (not shown). The ORC may be configured to receive input signals indicating occupant sensing and cargo sensing, for example to determine a vehicle load. The ADAS may include partially or fully autonomous driver aid systems such as, for example, adaptive cruise control, autonomous driving, and intelligent e-coasting.

Additionally, the supervisory controller 108 is in signal communication with the HMI/Nav 136, which could include a global navigation satellite system (GNSS) transceiver (not shown) configured to determine a precise geo-location of the vehicle 100 (e.g., precise coordinates of the vehicle). The HMI/Nav 136 could also be configured to determine and localize the position of the vehicle 100 relative to a map, such as a high-definition (HD) map. Map data could be stored remotely (e.g., at a remote server), locally (e.g., at the controller 108), or some combination thereof. The map data includes, among other things, a plurality of road segments each having varying road attributes (length, speed limit, curvature, elevation, grade, etc.). A navigational route for the vehicle 100 could include a plurality of these road segments from a start point to a desired end point. This route could be user-specified (e.g., via a driver input) or based on historical driving data/patterns, such as when/where the driver normally drives the vehicle 100. The information received from one or more of the described vehicle components/systems may assist supervisory controller 108 in predicting excessive energy generation in the electrified powertrain 106, as described herein in detail.

In the example embodiment, the supervisory controller 108 includes the excessive power/energy detection system 104 and is configured to predict, before or during a vehicle trip, excessive power/energy generation events. These events typically occur when the vehicle systems (e.g., engine 124, regen brake system 128, fuel cell system, etc.) generate a certain amount of power/energy that can neither be used by the vehicle systems nor stored in the HV battery system 120 (e.g., when fully charged or under certain restrictive conditions such as low battery power limits). These events may lead to various vehicle issues, including substantial vehicle range drop or vehicle inoperability.

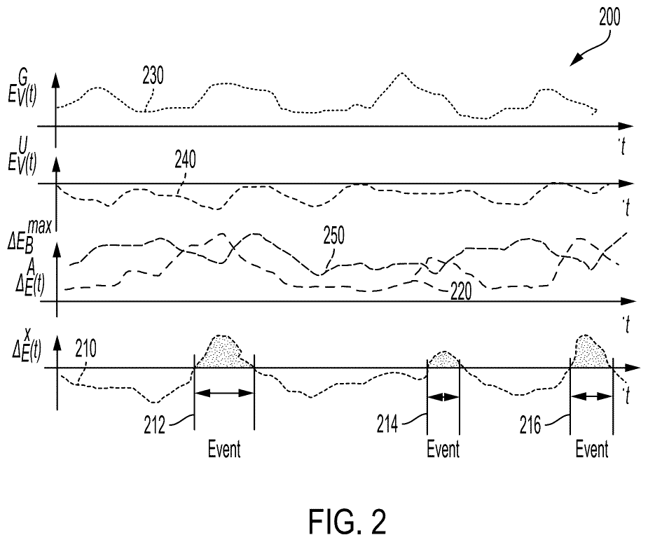

With reference now to FIG. 2, the excessive power/energy detection system 104 will be described in more detail. FIG. 2 illustrates a graph 200 showing vehicle conditions during example excessive power/energy scenarios. The excessive power/energy can be defined as an excess of power/energy

$$( {Δ}_{E}^{x} ( t ) )$$

that can neither be utilized for vehicle operation nor be stored in the HV battery system 120. Line 210 illustrates excess power/energy

$${Δ}_{E}^{x} ( t )$$

over time (t). The excessive power/energy detection is achieved by identifying the instances/events where

$${Δ}_{E}^{x} ( t )$$

is positive, for example, shown at 212, 214, and 216. In some cases, a certain number of the vehicle energy trajectories needed to determine

$${Δ}_{E}^{x} ( t )$$

can be predicted based upon the trip and vehicle conditions. They can be generated before the departure and updated during the trip.

In the example illustration, line 220 shows an available positive power/energy

$${Δ}_{E}^{A} ( t ) ,$$

which corresponds to a difference between a power/energy generated by the vehicle

$${E}_{V}^{G} ( i )$$

(line 230) and the power/energy used by the vehicle

$${E}_{V}^{U} ( t )$$

(line 2401) its operation. Thus,

$${Δ}_{E}^{A} ( t ) = {E}_{V}^{G} ( t ) - {E}_{V}^{U} ( t ) .$$

Accordingly, the HV battery power/energy E_{B} (t), at any time t, can be determined as:

$${E}_{B} ( t ) = {E}_{B} ( t - 1 ) + {Δ}_{E}^{A} ( t ) .$$

In the event of the battery is fully charged (i.e., maximum power/energy

$${E}_{B}^{max}$$

(line 250)), the excess of power/energy

$${Δ}_{E}^{x} ( t )$$

becomes:

$${Δ}_{E}^{x} ( t ) = {Δ}_{E}^{A} ( t ) - {Δ}_{E B}^{max} ( t ) ,$$

where

$${Δ}_{E B}^{max} ( t ) = {E}_{B}^{max} - {E}_{B} ( t - 1 ) ,$$

as the maximum power/energy the HV battery can store during that iteration.

In the event the HV battery is unable to store any power/energy, the excess power/energy

$${Δ}_{E}^{x} ( t )$$

is:

$${Δ}_{E}^{x} ( t ) = {Δ}_{E}^{A} ( t ) .$$

The excessive power/energy detection is ultimately achieved by determining the instances where

$${Δ}_{E}^{x} ( i )$$

is positive.

Before and during the trip, with advance knowledge of future trip information from departure to destination, the entire route can be split into several segments (e.g., city, highway, uphill, downhill). Each segment may include corresponding constraints, such as road conditions (e.g., speed limits, traffic, slope, obstructions, climate conditions, connectivity, charging and gas stations locations). Each segment may also account for various known vehicle conditions (e.g., states of HV battery 120, engine 124, electric motors 112, brake system 128), and vehicle operation trajectories (e.g., propulsion energy trajectories, thermal conditioning energy trajectories, and auxiliary energy trajectories, etc.) can be predicted. Moreover, the energy trajectories can be decomposed into user/sink and generation/source sub-energy trajectories. As an example, while the thermal and auxiliary systems energy trajectories are often considered as energy/power users/sinks

$${E}_{V}^{U , i} ( t ) ,$$

other trajectories such as engine, electric motors, and HV battery can be either energy users/sinks

$${E}_{V}^{U , i} ( t )$$

or energy generators/source

$${E}_{V}^{G , j} ( t ) .$$

Once the energy trajectories for the “i” users/sinks and “j” generators/sources are predicted, simple computation can be conducted to find the total energy trajectories

$${E}_{V}^{U} ( t ) and {E}_{V}^{G} ( t )$$

and ultimately

$${Δ}_{E}^{x} ( t )$$

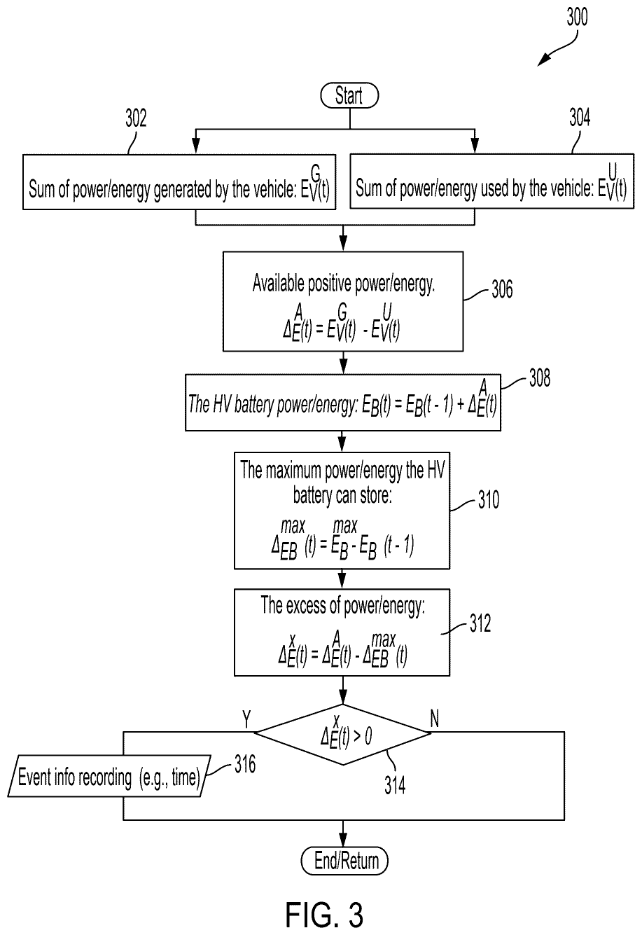

as per the above equations. As shown in FIG. 3, any time

$${Δ}_{E}^{x} ( t )$$

is detected and its related information is recorded.

Referring now to FIG. 3, a flow diagram of an example excessive power/energy prediction/detection method 300 for an electrified vehicle according to the principles of the present application is illustrated. While the vehicle 100 and the components of FIG. 1 are specifically referenced for illustrative/descriptive purposes, it will be appreciated that the method 300 could be applicable to any suitably configured electrified vehicle. The method 300 begins at step 302 where supervisory controller 108 (“control”) determines the sum of power/energy generated by the vehicle

$$( {E}_{V}^{G} ( t ) )$$

for a predetermined time period such as, for example, a current drive cycle or during a route to a destination entered into the HMI/navigation system 136. At 304, control determines the sum of power/energy used by the vehicle

$$( {E}_{V}^{U} ( t ) )$$

during the predetermined time period.

At 306, control determines the available positive power/energy of the vehicle

$$( {Δ}_{E}^{A} ( t ) )$$

based on the determinations from steps 302 and 304. At 308, control determines the HV battery power/energy

$$( {E}_{B} ( t ) = {E}_{B} ( t - 1 ) + {Δ}_{E}^{A} ( t ) ) .$$

At 310, control determines the maximum power/energy the HV battery system 120 can store

$$( {Δ}_{E B}^{max} ( t ) = {E}_{B}^{max} - {E}_{B} ( t - 1 ) ) .$$

At 312, control determines the excess power/energy of the vehicle

$$( {Δ}_{E}^{x} ( t ) = {Δ}_{E}^{A} ( t ) - {Δ}_{E B}^{max} ( t ) ) .$$

At 314, control then checks if the excess power/energy

$$( {Δ}_{E}^{x} ( t ) )$$

is positive at that time ‘t’. If the excess power/energy is determined to be positive, then at 316, control records/stores the information related to that event. If not, then control ends. By identifying the instance(s)/time(s) when the excess power/energy will be positive, the controller 108 (or other controller(s)) may implement so-called excess power/energy avoidance control solutions to prevent or minimize the excess power/energy generation, thereby preventing potential vehicle system states that may lead to reduced vehicle range and/or vehicle component inoperability/damage. Control may then end or return to 302 for one or more iterations.

It will be appreciated that the term “controller” or “module” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

1. An excessive power/energy prediction system for an electrified vehicle (EV), the excessive power/energy detection system comprising:
an electrified powertrain including at least one electric traction motor;
a high voltage (HV) battery system configured to power the at least one electric traction motor;
a regenerative brake system configured to selectively recharge the HV battery system;
a sensor system configured to measure operating parameters of the EV including at least a state of charge (SOC) of the HV battery system; and
a controller having one or more processors and a non-transitory computer-readable storage medium having a plurality of instructions stored thereon, which, when executed by the one or more processors, cause the one or more processors to perform operations comprising:
determine a sum of power/energy that will be generated by the EV for a predetermined time period corresponding to a navigational route or a current drive cycle;
determine a sum of power/energy to be utilized by the EV for the predetermined time period;
determine an available positive power/energy of the EV based on a difference between the determined sum of power/energy generated by the EV and the determined sum of power/energy to be utilized by the EV;
determine, by the sensor system, a current amount of power/energy of the HV battery system for the predetermined time period;
determine, by the sensor system, a maximum amount of power/energy the HV battery system can store for the predetermined time period;
determine when an excess generated power/energy will occur during the predetermined time period based on when the determined available positive power/energy of the EV exceeds the determined maximum amount of power/energy the HV battery system can store;
identify and record one or more future excessive power/energy generation events within the predetermined time period, the one or more future excessive power/energy events corresponding to when the determined excess generated power/energy will occur; and
in response, implement an excess power/energy avoidance control operation of the EV to prevent or minimize the one or more future excessive power/energy generation events.

2. The excessive power/energy detection system of claim 1, wherein the controller is further configured to:
determine a current state of charge (SOC) of the HV battery system; and
determine a maximum SOC of the HV battery system.

3. The excessive power/energy detection system of claim 2, wherein the controller is further configured to:
determine if the current SOC is greater than or equal to the maximum SOC.

4. The excessive power/energy detection system of claim 3, wherein the controller is further configured to:
determine the excess generated power/energy is equal to the determined available positive power/energy, if the current SOC is greater than or equal to the maximum SOC.

5. The excessive power/energy detection system of claim 1, wherein the predetermined time period is the current drive cycle.

6. The excessive power/energy detection system of claim 1, wherein the predetermined time period is the navigational route.

7. The excessive power/energy detection system of claim 6, wherein the navigational route is based on a destination entered into a navigation system associated with the EV.

8. The excessive power/energy detection system of claim 6, wherein the navigational route is based on historical driving data.

9. The excessive power/energy detection system of claim 6, wherein the determined sum of power/energy to be utilized by the EV for the predetermined time period is based on: (i) an electric traction motor power consumption input, (ii) a thermal management system thermal state input and thermal power consumption input, (iii) an HVAC system power consumption input, and (iv) a vehicle accessory power consumption input.

10. The excessive power/energy detection system of claim 9, wherein the determined sum of power/energy to be utilized by the EV for the predetermined time period is further based on: (a) a vehicle load/cargo weight estimation, (b) a vehicle occupancy status, (c) a tire pressure, (d) a distance to a destination of travel, (e) a time to the destination of travel, (f) speed limits along the navigational route, (g) traffic information along the navigational route, (h) a selected vehicle drive mode, (i) a selected regenerative braking mode, (j) a vehicle speed, (k) a vehicle historic energy usage from memory, and (l) an individual driver habits profile.

11. An excessive power/energy prediction method for an electrified vehicle (EV) having an electrified powertrain including an electric traction motor powered by a high voltage (HV) battery system, a regenerative brake system configured to selectively recharge the HV battery system, and a sensor system configured to measure operating parameters of the EV including at least a state of charge (SOC) of the HV battery system, the method comprising:
determining, by a controller having one or more processors, a sum of power/energy that will be generated by the EV for a predetermined time period corresponding to a navigational route or a current drive cycle;
determining, by the controller, a sum of power/energy to be utilized by the EV for the predetermined time period;
determining, by the controller, an available positive power/energy of the EV based on a difference between the determined sum of power/energy generated by the EV and the determined sum of power/energy to be utilized by the EV;
determining, by the controller and the sensor system, a current amount of power/energy of the HV battery system for the predetermined time period;
determining, by the controller and the sensor system, a maximum amount of power/energy the HV battery system can store for the predetermined time period;
determining, by the controller, when an excess generated power/energy will occur during the predetermined time period based on when the determined available positive power/energy of the EV exceeds the determined maximum amount of power/energy the HV battery system can store;
identifying and recording, by the controller, one or more future excessive power/energy generation events within the predetermined time period, the one or more future excessive power/energy generation events corresponding to when the determined excess generated power/energy occurs; and
in response, implementing, by the controller, an excess power/energy avoidance control operation of the EV to prevent or minimize the one or more future excessive power/energy events.

12. The method of claim 11, further comprising:
determining, by the controller, a current state of charge (SOC) of the HV battery system; and
determining, by the controller, a maximum SOC of the HV battery system.

13. The method of claim 12, further comprising:
determining, by the controller, if the current SOC is greater than or equal to the maximum SOC.

14. The method of claim 13, further comprising:
determining, by the controller, the excess generated power/energy is equal to the determined available positive power/energy, if the current SOC is greater than or equal to the maximum SOC.

15. The method of claim 11, wherein the predetermined time period is the current drive cycle.

16. The method of claim 11, wherein the predetermined time period is the navigational route.

17. The method of claim 16, wherein the navigational route is based on a destination entered into a navigation system associated with the EV.

18. The method of claim 16, wherein the navigational route is based on historical driving data.

19. The method of claim 16, wherein the determined sum of power/energy to be utilized by the EV for the predetermined time period is based on: (i) an electric traction motor power consumption input, (ii) a thermal management system thermal state input and thermal power consumption input, (iii) an HVAC system power consumption input, and (iv) a vehicle accessory power consumption input, and
wherein the determined sum of power/energy to be utilized by the EV for the predetermined time period is further based on: (a) a vehicle load/cargo weight estimation, (b) a vehicle occupancy status, (c) a tire pressure, (d) a distance to a destination of travel, (e) a time to the destination of travel, (f) speed limits along the navigational route, (g) traffic information along the navigational route, (h) a selected vehicle drive mode, (i) a selected regenerative braking mode, (i) a vehicle speed, (k) a vehicle historic energy usage from memory, and (l) an individual driver habits profile.

20. (canceled)

21. An electrified vehicle (EV), comprising:
an electrified powertrain including at least one electric traction motor;
a high voltage (HV) battery system configured to power the at least one electric traction motor;
a brake system having a regenerative braking capability configured to selectively recharge the HV battery system;
a thermal management system including one or more thermal actuators configured to thermally condition the electrified powertrain;
a navigation system configured to determine a navigational route based on at least one of a destination entered by a driver or historical driving data associated with the EV;
a sensor system configured to measure operating parameters of the EV including at least a state of charge (SOC) of the HV battery system; and
a supervisory controller having one or more processors and a non-transitory computer-readable storage medium having a plurality of instructions stored thereon, which, when executed by the one or more processors, cause the one or more processors to perform operations comprising:
determine a sum of power/energy generated by the EV for a predetermined time period corresponding to the navigational route;
determine a sum of power/energy to be utilized by the EV for the predetermined time period;
determine an available positive power/energy of the electrified vehicle based on a difference between the determined sum of power/energy generated by the electrified vehicle and the determined sum of power/energy to be utilized by the electrified vehicle;
determine a current amount of power/energy of the HV battery system for the predetermined time period based on a current SOC of the HV battery system;
determine a maximum amount of power/energy the HV battery system can store for the predetermined time period based on a maximum SOC of the HV battery system;
determine when an excess generated power/energy will occur during the predetermined time period based on when the determined available positive power/energy of the EV exceeds the determined maximum amount of power/energy the HV battery system can store, the excess generated power/energy representing power/energy that can neither be utilized for vehicle operation nor stored in the HV battery system;
record event information associated with each instance during the predetermined time period in which the excess generated power/energy occurs; and
proactively implement an excess power/energy avoidance control operation before or during the navigational route to prevent or minimize the excess generated power/energy, to thereby prevent vehicle range deterioration and vehicle component damage.
